(19) United States
(12) Patent Application Publication
(10) Pub. No.: US 2009/0223643 A1
(43) Pub. Date: Sep. 10, 2009

(54) Transverse Moving Apparatus For Double-Layer Window Covering

(76) Inventor: Li-Ming CHENG, Kaohsiung City (TW)

Correspondence Address: FRENKEL & ASSOCIATES, 3975 UNIVERSITY DR., STE. 330, FAIRFAX, VA, 22030, US

(21) Appl. No.: 12/042,734

(22) Filed: Mar. 5, 2008

(51) Int. Cl. E06B 9/00

(52) U.S. Cl. 160/368.1

(57) ABSTRACT

A transverse moving apparatus for a double-layer window covering which has an upper elongated support, a lower elongated support, a transverse moving means, a shade assembly and a transmission assembly. The transverse moving means is installed in the upper elongated support and includes a moving assembly, an actuation assembly and a holding assembly. The actuation assembly is linked to the moving assembly located on the holding assembly so that the moving assembly can be driven by the actuation assembly to move. Thereby a first shade and a second shade of the shade assembly can be moved and overlapped to adjust the size of bright and dark zones and regulate lighting and dark condition.

### FIELD OF THE INVENTION

The present invention relates to a transverse moving apparatus for double-layer window coverings that has an actuation assembly linking to a moving assembly located on a holding assembly to allow manual control of the actuation assembly to regulate a first shade and a second shade of a double-layer shade assembly to adjust lighting and dark effect.

### BACKGROUND OF THE INVENTION

There are many different types of window coverings on the market such as pleated shades, roman shades and the like. They mainly aim to be installed at doors and windows of houses to block sunshine and serve decorative purpose. When in use to control lighting brightness and darkness the window coverings usually are rolled upwards to receive or block light across a whole swathe. Such a structure creates many problems in practice, notably:

To control light projection through the conventional window coverings the entire shade of a window covering has to be rolled upwards. Adjusting light projection amount to suit user's requirement is difficult. Practicality of the window covering is not desirable.

To remedy the aforesaid problem a double-layer window covering 10 allowing users to adjust lighting and darkness has been developed as shown in FIGS. 1 and 2. It includes an upper elongated support 11, a lower elongated support 12, a transverse moving means 13, a shade lift cord assembly 14 and a transmission assembly 15. The transverse moving means 13 is located in the upper elongated support 11 and has a first plate 131 with one side fastened by a first cord 141 of the shade lift cord assembly 14. The first lift cord 141 threads through a first aperture 111 of the upper elongated support 11. The shade lift cord assembly 14 also has a second lift cord 142 with other end winding a guiding wheel 1331 of a latch element 133 and threading through a second aperture 112 of the upper elongated support 11. Thereby the first and second plates 131 and 132 fastened respectively to a first and a second fastening members 135 and 136 and bridged by a latch rod 134 can be moved synchronously. When the second lift cord 142 is pulled (referring to FIG. 3), a first shade 21 of a shade assembly 20 fastened under the first and second plates 131 and 132 is moved to one side from an original position overlapped with a second shade 22 in a dark zone to a new position where the zebra-striped first and second shades 21 and 22 have their dark segments overlapped to form a bright zone. When the first lift cord 141 is pulled, the first shade 21 fastened to the bottom of the first and second plates 131 and 132 is moved to other side relative to the second shade 22 from a maximum bright zone to a smaller bright zone or the dark zone, thereby the lighting and dark condition can be adjusted. However, the structure mentioned above is complicated and requires a lot of elements. Assembly and installation are difficult. Operation is troublesome. The practicality is lower. There is still room for improvement.

### SUMMARY OF THE INVENTION

The present invention aims to provide a transverse moving apparatus for double-layer window coverings to solve the problem of the conventional window shades that is difficult to adjust light projection and to effectively regulate bright and dark overlapping size of a first shade and a second shade of a double-layer window covering to adjust lighting and dark condition.

To achieve the foregoing object the invention provides a transverse moving apparatus for a double-layer window covering which has an upper elongated support, a lower elongated support, a transverse moving means, a shade assembly and a transmission assembly. The transverse moving means is installed in the upper elongated support and includes at least a moving assembly, an actuation assembly and a holding assembly. The moving assembly has a first plate and a second plate located at two sides of a guiding trough in the upper elongated support, and a latch rod latched on two outer sides of the first and second plates. The actuation assembly has a strip which may be a rope with one end fastened to a front end of the first plate and other end threading through a slot formed at a front side of the upper elongated support. The holding assembly has a first fastening plate and a second fastening plate that correspond to each other. The first and second fastening plates are fastened to the bottom of the first and second plates close to a first aperture and a second aperture at two ends of the upper elongated support. The actuation assembly and the moving assembly located on the holding assembly are linked so that they can be moved at the same time to adjust the lighting and dark condition.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a front view of a conventional double-layer window covering in a use condition;

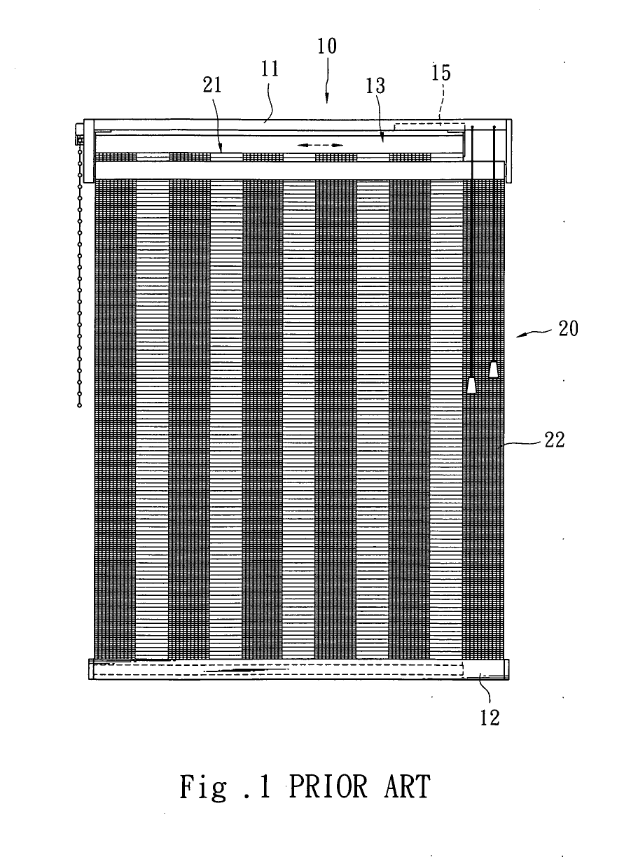

FIG. 2 is an exploded view of a transverse moving means of a conventional double-layer window covering;

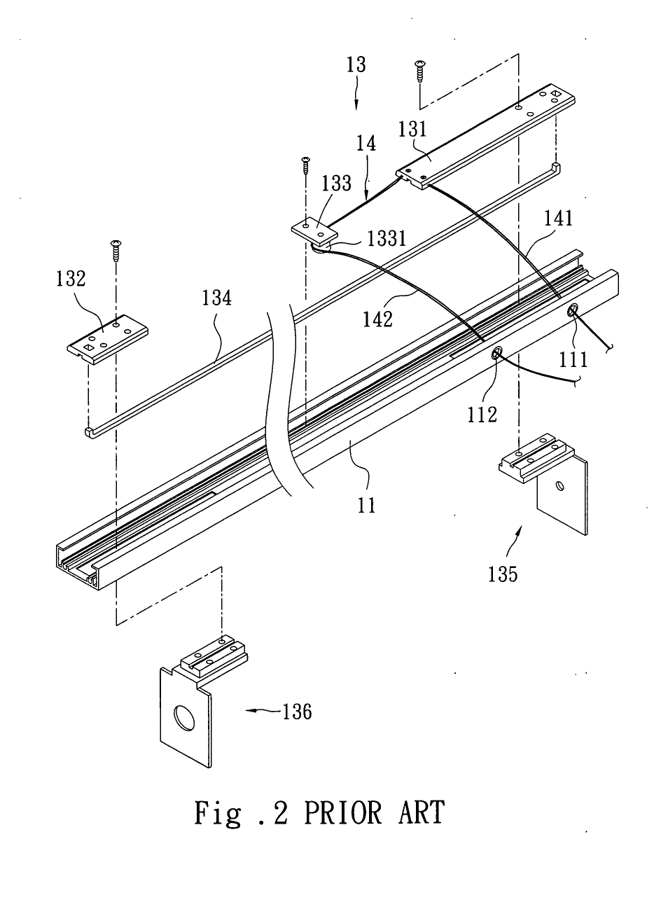

FIG. 3 is a schematic view a conventional double-layer window covering in a condition of pulling a second lift cord of the transverse moving means;

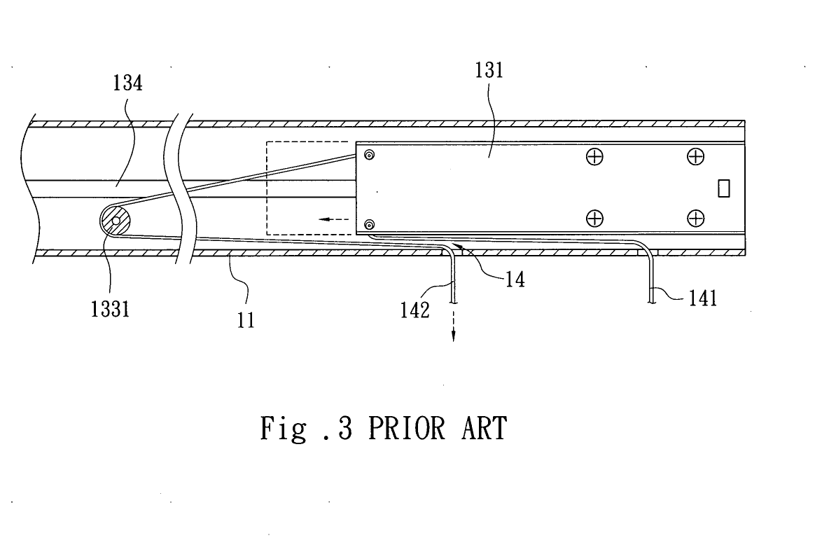

FIG. 4 is an exploded view of the transverse moving apparatus of the invention;

FIG. 5 is an exploded view of another embodiment of a guiding member of the transverse moving apparatus;

FIG. 6 is an exploded view of yet another embodiment of the guiding member of the transverse moving apparatus;

FIG. 7 is an exploded view of still another embodiment of the guiding member of the transverse moving apparatus;

FIG. 8 is a schematic view of the invention showing the actuation assembly of the transverse moving apparatus pulled from one side;

FIG. 9 is a schematic view of the invention showing the actuation assembly of the transverse moving apparatus pulled from another side;

FIG. 10 is an exploded view of another embodiment of the actuation assembly and a first plate of the invention;

FIG. 11 is a schematic view of the actuation assembly and the first plate moved sideward according to FIG. 10;

FIG. 12 is an exploded view of yet another embodiment of the actuation assembly and the first plate of the invention;

FIG. 13 is a schematic view of the actuation assembly and the first plate moved sideward according to FIG. 12; and

FIG. 14 is an exploded view of still another embodiment of the actuation assembly and the first plate of the invention.

### DETAILED DESCRIPTION OF THE PREFERRED EMBODIMENTS

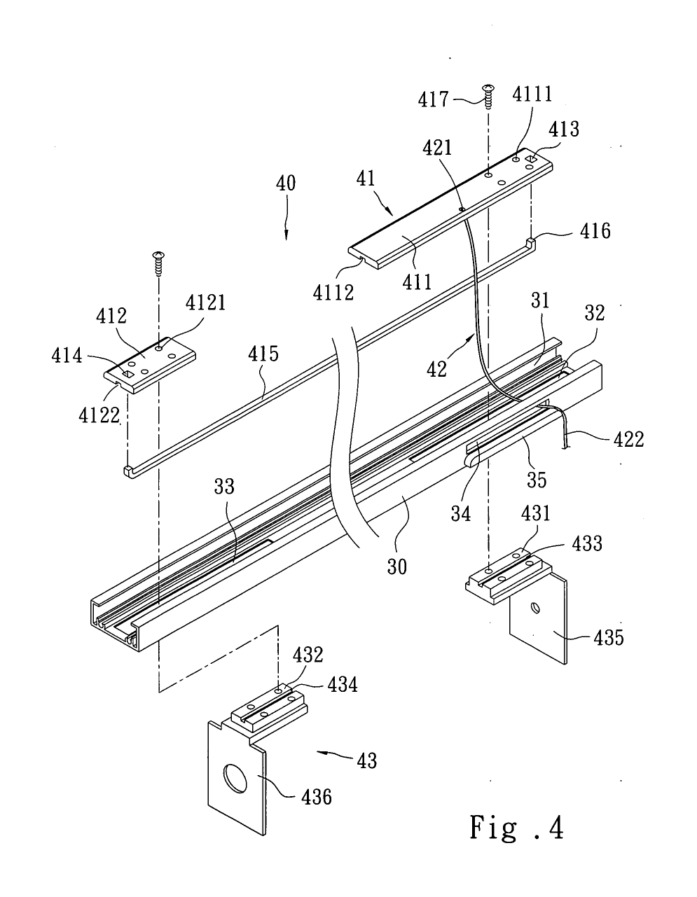

Please refer to FIG. 4, the double-layer window covering according to the invention has an upper elongated support 30, a lower elongated support (not shown in the drawing) spaced from the upper elongated support 30 at a lower side, a transverse moving means 40, a shade assembly 50 and a transmission assembly 60.

The upper elongated support 30 has a guiding trough 31 inside and a first aperture 32 and a second aperture 33 close to two ends thereof, a slot 34 at a front side of one end, and a guiding member 35 below an outer side of the slot 34.

The transverse moving means 40 is located in the guiding trough 31 of the upper elongated support 30 and includes at least:

a moving assembly 41 consisting of a first plate 411 and a second plate 412 held in the guiding trough 31, and a latch rod 415 which has two latch elements 416 at two ends thereof. The first and second plates 411 and 412 are located respectively above the first and second apertures 32 and 33, and movable reciprocally at two ends of the guiding trough 31. The first plate 411 and second plate 412 have respectively fastening holes 4111 and 4121 to receive fastening elements 417 such as screws or the like, and a first latch trough 4112 and a second latch trough 4122 at the bottom that correspond to each other. The latch rod 415 is wedged in the first and second latch troughs 4112 and 4122 with the latch elements 416 at the two ends inserted into coupling holes 413 and 414 at two outer sides of the first and second plates 411 and 412;

a holding assembly 43 which has a first fastening plate 431 and a second fastening plates 432 that correspond to each other and are fastened to the bottom of the first and second plates 411 and 412 close to the first and second apertures 32 and 33, and have respectively a groove 433 and 434 in the center to hold the latch rod 415, and an upright plate 435 and 436 at one end thereof directing downwards; and

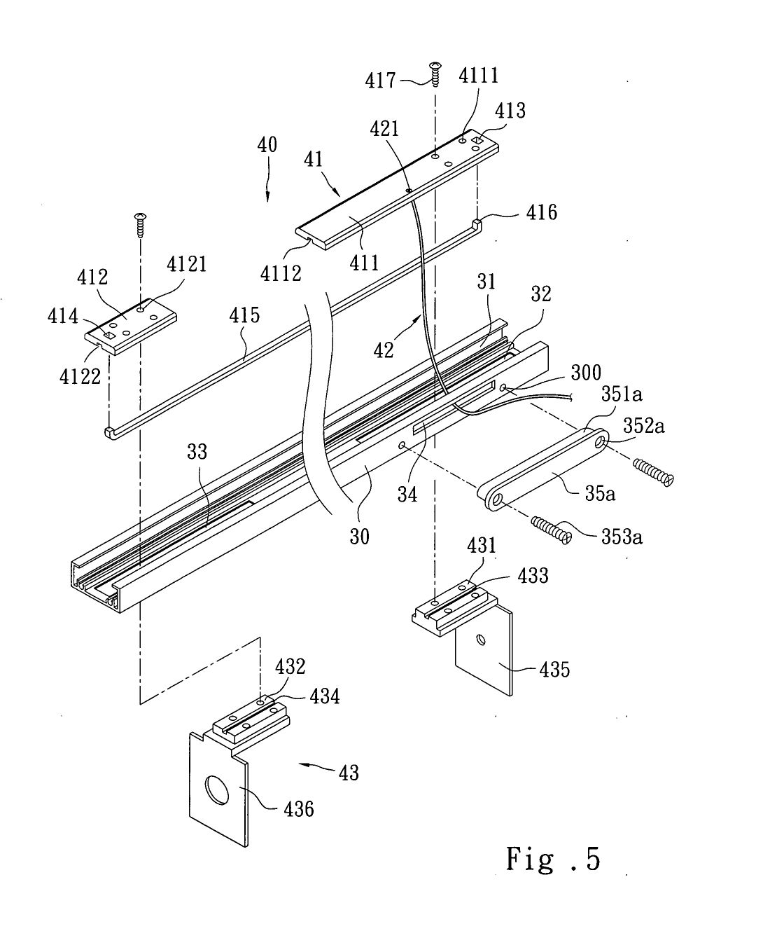

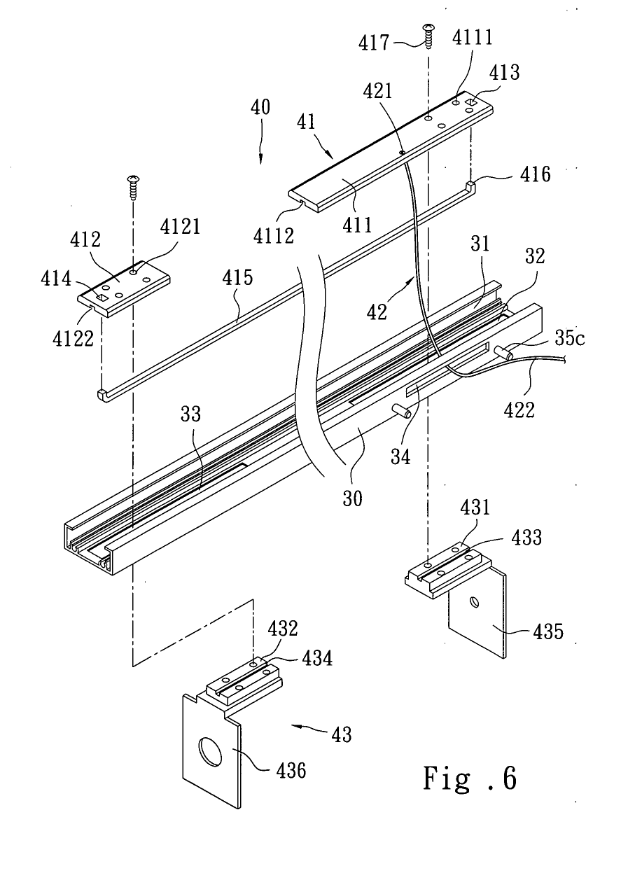

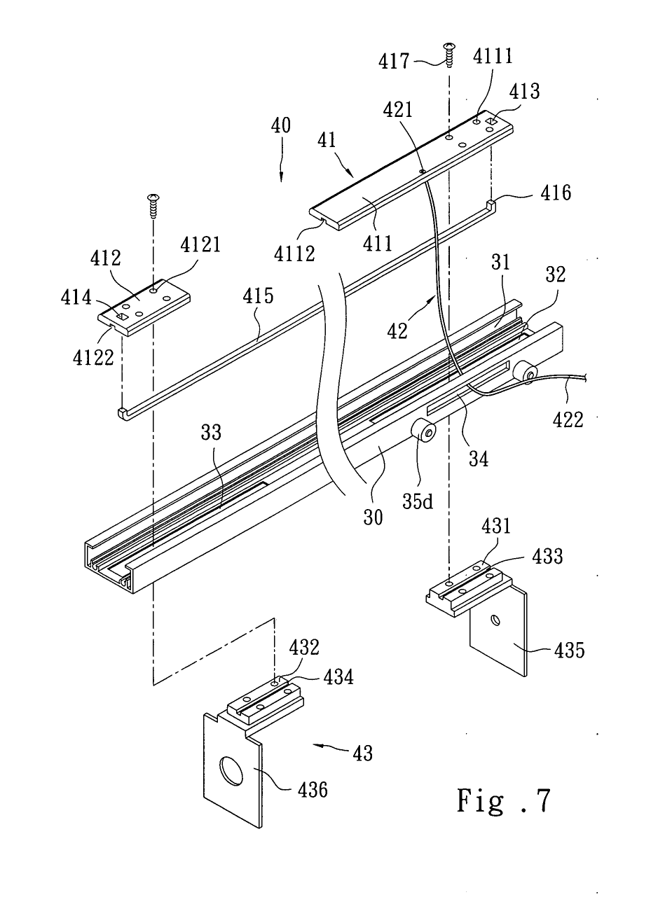

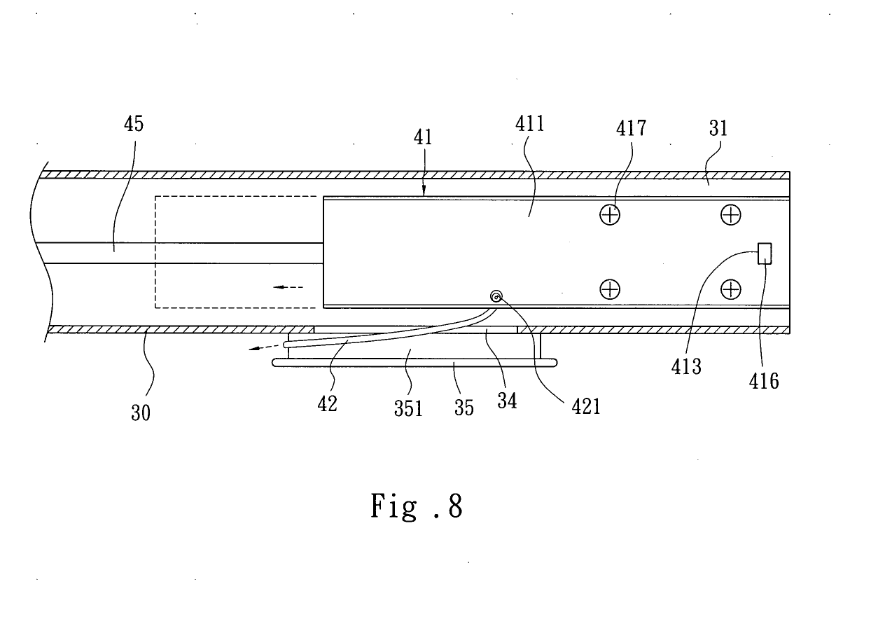

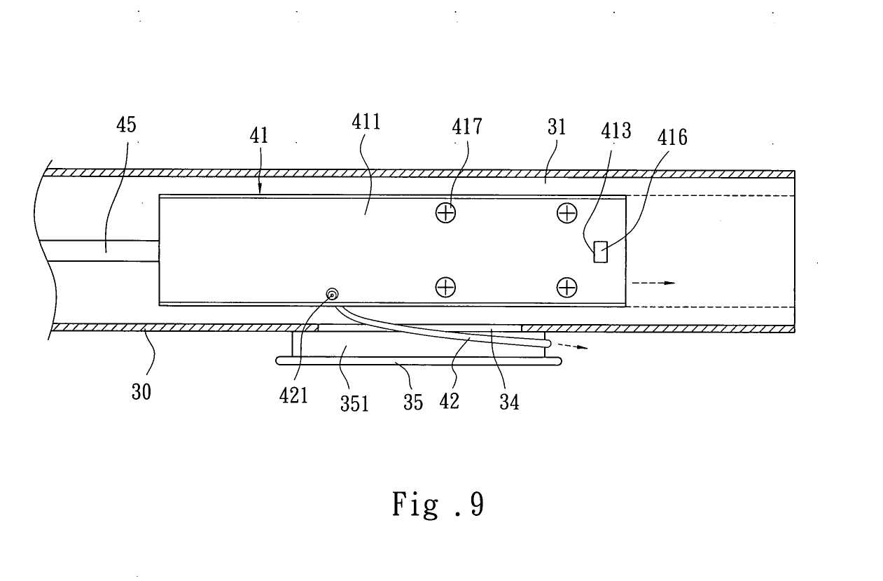

an actuation assembly 42 which includes a strip. In an embodiment shown in FIG. 4, it is a flexible rope with one end 421 fastened to a front end of the first plate 411 and other end 422 threading through the slot 34 of the upper elongated support 30 to wind on the guiding member 35 to move the first and second plates 411 and 412 transversely (referring to FIGS. 8 and 9). The guiding member 35 is a plank as shown in FIG. 4, or a jutting element 35a as shown in FIG. 5 with a directing trough 351a formed thereon and two sunken holes 352 at two ends to be run through by fastening elements 353a and are fastened to fastening holes 300 formed on outer sides of the upper elongated support 30. Other embodiments may also be adopted, such as the one shown in FIG. 6 in which the guiding member 35c has more than one set spaced from each other on an outer side of the upper elongated support 30 below the slot 34; or the guiding member 35d may be a roller as shown in FIG. 7 to reduce resistant force while the actuation assembly 42 is pulled.

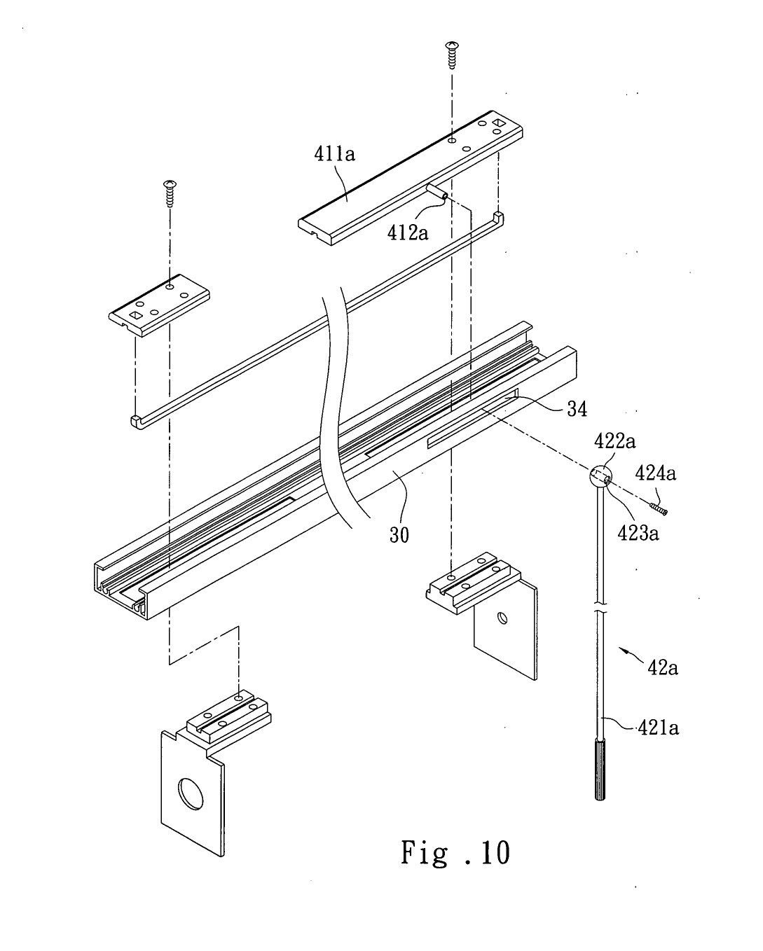

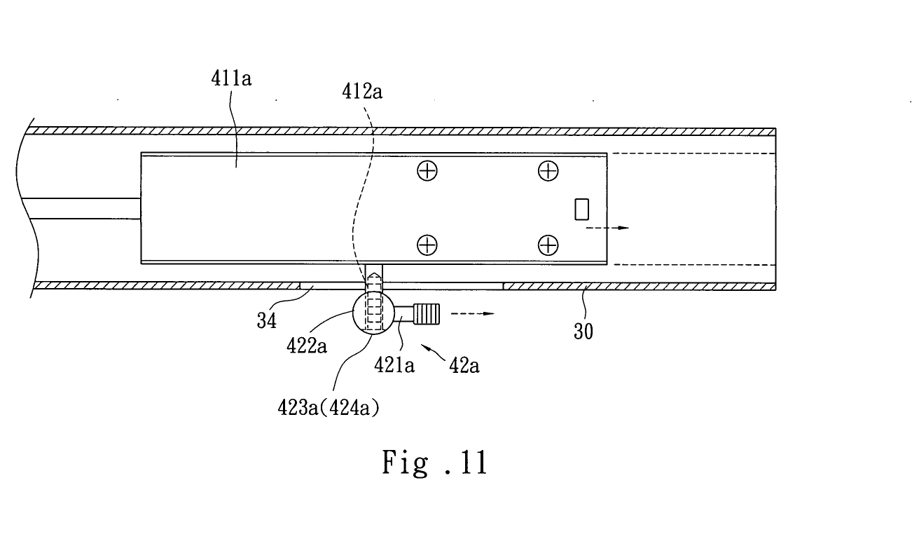

Referring to FIG. 10, the actuation assembly 42a includes a strip which may be a hard rod 421a. The rod 421a has a coupling portion 422a at one end with a screw hole 423a formed thereon to be run through by a fastening element 424a to be fastened to a fastening hole 4112a passing through the slot 34 at the front end of the first plate 411a. Thus when the hard rod 421a is moved the shade assembly (not shown in the drawings) beneath the first plate 411a also can be moved transversely at the same time (referring to FIG. 11).

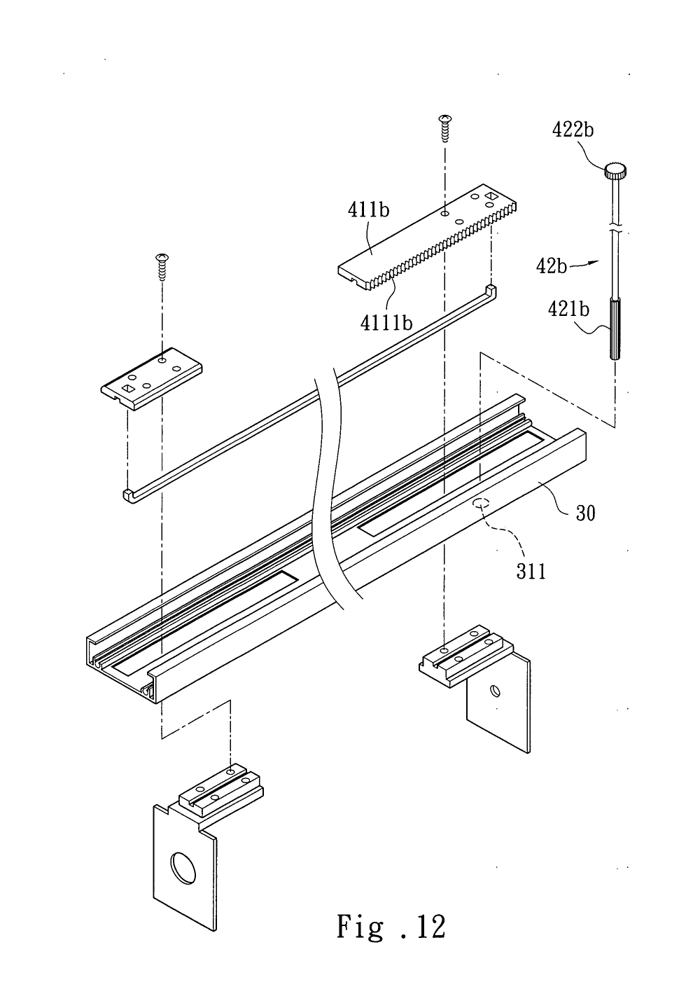

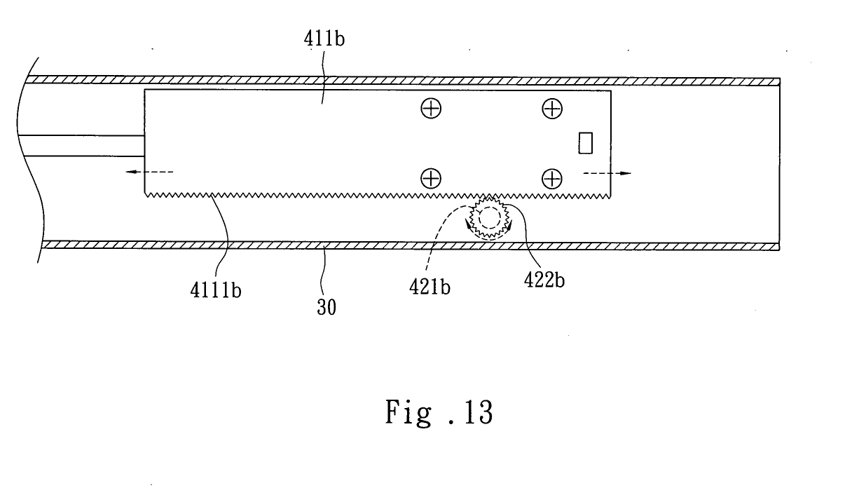

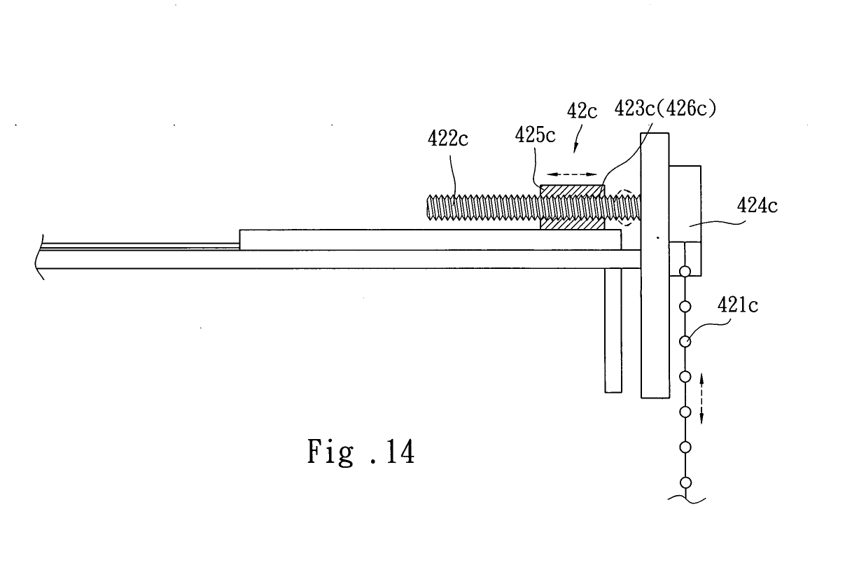

Referring to FIG. 12, the actuation assembly 42b includes a strip which may be a hard rod 421b. The rod 421b is coupled with a gear 422b to run through an opening 311 formed at a front end of the guiding trough 31 of the upper elongated support 30 to be engaged with a gear rack 4111b at a front edge of the first plate 411b. Thus when the hard rod 421b is rotated the gear 422b at one end thereof also rotates to drive the gear rack 4111b to move transversely at the same time (referring to FIG. 13). Yet another approach is shown in FIG. 14 in which the actuation assembly 42c has a strip formed in a bead chain 421c, and a transmission shaft 422c with a screw thread portion 423c at one end and a coupling portion 424c at other end. The first plate 425c has a screwing portion 426c at one end engaging with the screw thread portion 423c while the coupling portion 424c is wound by the bead chain 421c.

By means of the constructions set forth above, when adopted on the double-layer window covering to extend and retract the first and second shades (not shown in the drawings), referring to FIG. 8, the transverse moving means 40 is held in the upper elongated support 30, the actuation assembly 42 at one side of the first plate 411 threads through the upper elongated support 30 to wind the guiding member 35, and the first and second plates 411 and 412 are moved synchronously through the latch rod 415. When the actuation assembly 42 is pulled in one direction, the first shade (not shown in the drawings) fastened to the first and second plates 411 and 412 is moved towards one side from an original overlapping position with the second shade in a dark zone to a new position where the zebra-striped first and second shades have their dark segments overlapped to form a bright zone. Referring to FIG. 9, when the actuation assembly 42 is pulled in an opposite direction, the first shade fastened to the bottom of the first and second plates 411 and 412 are moved to other side against the second shade from a maximum bright zone to a smaller bright zone or the dark zone, thereby users can adjust the lighting and dark condition as desired.

What is claimed is:

1. A transverse moving apparatus for double-layer window coverings located in an upper elongated support, comprising at least:
a moving assembly including a first plate and a second plate located at two ends of the upper elongated support and a latch rod which is located in the upper elongated support and has two ends coupled on the first plate and the second plate;
an actuation assembly coupled to the first plate; and
a holding assembly which has a first fastening plate and a second fastening plate that correspond to each other and are fastened respectively to the bottom of the first plate and the second plate and have respectively an upright plate at one end thereof directing downwards.

2. The transverse moving apparatus of claim 1, wherein the actuation assembly includes a strip.

3. The transverse moving apparatus of claim 2, wherein the strip is a flexible rope.

4. The transverse moving apparatus of claim 2, wherein the upper elongated support has at least one guiding member at a front end thereof wound by the strip.

5. The transverse moving apparatus of claim 4, wherein the guiding member has a directing trough.

6. The transverse moving apparatus of claim 4, wherein the guiding member is a roller.

7. The transverse moving apparatus of claim 2, wherein the strip is a hard rod which has a coupling portion at one end fastened to a corresponding fastening hole at a front side of the first plate.

8. The transverse moving apparatus of claim 2, wherein the strip is a hard rod coupled with a gear to engage with a corresponding gear rack at a front side of the first plate.

9. The transverse moving apparatus of claim 2, wherein the strip is a bead chain.

10. The transverse moving apparatus of claim 9, wherein the actuation assembly includes a transmission shaft which has a screw thread portion at one end and a coupling portion at other end, the first plate having a screwing portion screwed with the screw thread portion, the coupling portion being wound by the bead chain.
